(19) United States
(12) Patent Application Publication
(10) Pub. No.: US 2018/0225590 A1
(43) Pub. Date: Aug. 9, 2018

(54) AUTOMATIC GROUND TRUTH SEEDER

(71) Applicant: INTERNATIONAL BUSINESS MACHINES CORPORATION, Armonk, NY (US)

(72) Inventors: FAHEEM ALTAF, PFLUGERVILLE, TX (US); LISA SEACAT DELUCA, BALTIMORE, MD (US); RAGHURAM SRINIVAS, MCKINNEY, TX (US)

(21) Appl. No.: 15/426,236

(22) Filed: Feb. 7, 2017

(51) Int. Cl. G06N 99/00; G06F 17/30

(52) U.S. Cl. CPC G06N 99/005; G06F 17/3053

(57) ABSTRACT

Processors are configured to select an item from a corpus of different items each including a descriptive title and unique indicia, and enter the descriptive title of the selected item into a query field of a new entry for a ground truth file, wherein the ground truth file new entry includes the query field, an answer field, and a relevancy score field. The aspect processors further enter the unique item indicia of the selected item title into the answer field of the new entry, set a value of the relevancy score field of the new entry to a high relevancy value, and add the new ground truth file entry to the ground truth file. Some processor aspects further train a ranker with the ground truth file.

### BACKGROUND

Cognitive search devices and applications powered by cognition and natural language recognition generally require ground truth definitions to train underlying statistical algorithms. Search results may thus be retrieved from a search of one or more corpora (corpuses) in satisfaction of a user query and ranked by their relative relevancy to the query in a learning process that re-ranks unknown results by comparison to known results within training data, which includes training data rankings. Illustrative but not limiting or exhaustive examples of corpora include database files, web page content, and JavaScript Object Notation (JSON) files.

Training data for cognitive search devices is generally created from an established ground truth data, a collection of questions (search queries) that are matched to answers that are each labeled with their respective relevance to the question. The relevance label helps the cognitive search device ranker to determine which features are the most useful. The questions, answers, and relevance labels are combined to create the training data, which is uploaded to create and train the automated ranker.

### BRIEF SUMMARY

In one aspect of the present invention, a computerized method for automatically seeding ground truth files includes executing steps on a computer processor. Thus, a computer processor selects an item from a corpus of different items each including a descriptive title and unique indicia, and enters the descriptive title of the selected item into a query field of a new entry for a ground truth file, wherein the ground truth file new entry includes the query field, an answer field, and a relevancy score field. The processor further enters the unique item indicia of the selected item title into the answer field of the new entry, sets a value of the relevancy score field of the new entry to a high relevancy value, and adds the new ground truth file entry to the ground truth file. Some processor aspects further train a ranker with the ground truth file.

In another aspect, a system has a hardware processor in circuit communication with a computer readable memory and a computer-readable storage medium having program instructions stored thereon. The processor executes the program instructions stored on the computer-readable storage medium via the computer readable memory and is thereby configured to select an item from a corpus of different items each including a descriptive title and unique indicia, and enter the descriptive title of the selected item into a query field of a new entry for a ground truth file, wherein the ground truth file new entry includes the query field, an answer field, and a relevancy score field. The configured processor further enters the unique item indicia of the selected item title into the answer field of the new entry, sets a value of the relevancy score field of the new entry to a high relevancy value, and adds the new ground truth file entry to the ground truth file. Some configured processor aspects further train a ranker with the ground truth file.

In another aspect, a computer program product for automatically seeding ground truth files has a computer-readable storage medium with computer readable program code embodied therewith. The computer readable hardware medium is not a transitory signal per se. The computer readable program code includes instructions for execution which cause the processor to select an item from a corpus of different items each including a descriptive title and unique indicia, and enter the descriptive title of the selected item into a query field of a new entry for a ground truth file, wherein the ground truth file new entry includes the query field, an answer field, and a relevancy score field. The processor is further caused to enter the unique item indicia of the selected item title into the answer field of the new entry, set a value of the relevancy score field of the new entry to a high relevancy value, and add the new ground truth file entry to the ground truth file. Some processor aspects are further caused to train a ranker with the ground truth file.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts abstraction model layers according to an embodiment of the present invention.

FIG. 3 depicts a computerized aspect according to an embodiment of the present invention.

FIG. 4 is a flow chart illustration of an embodiment of the present invention.

FIG. 5 is a flow chart illustration of another embodiment of the present invention.

FIG. 6 is a block diagram illustration of an aspect of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

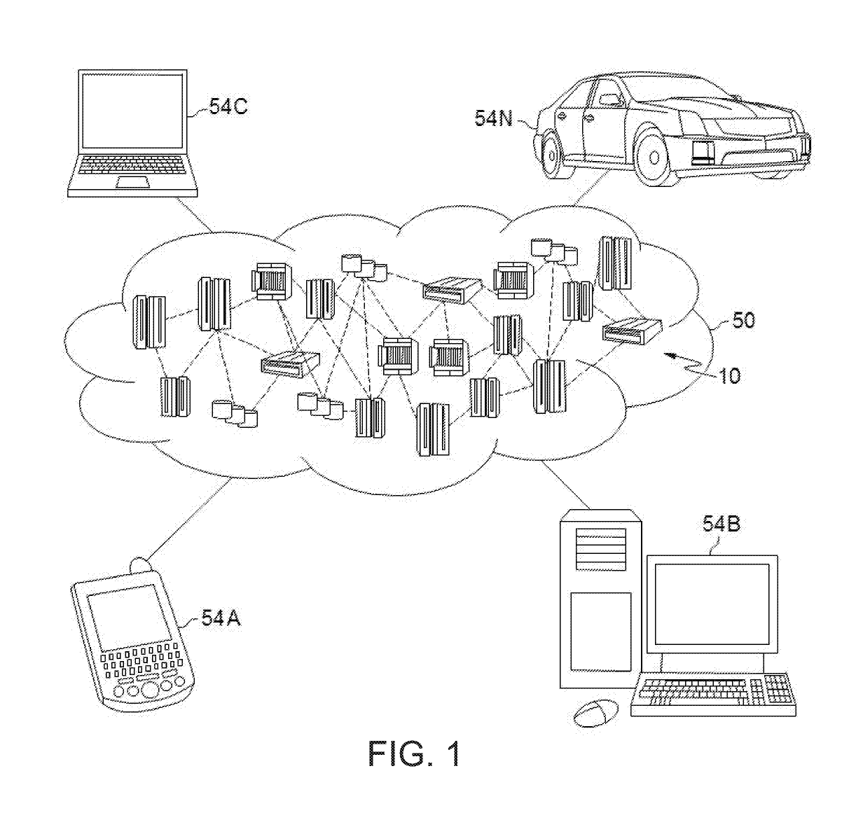

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

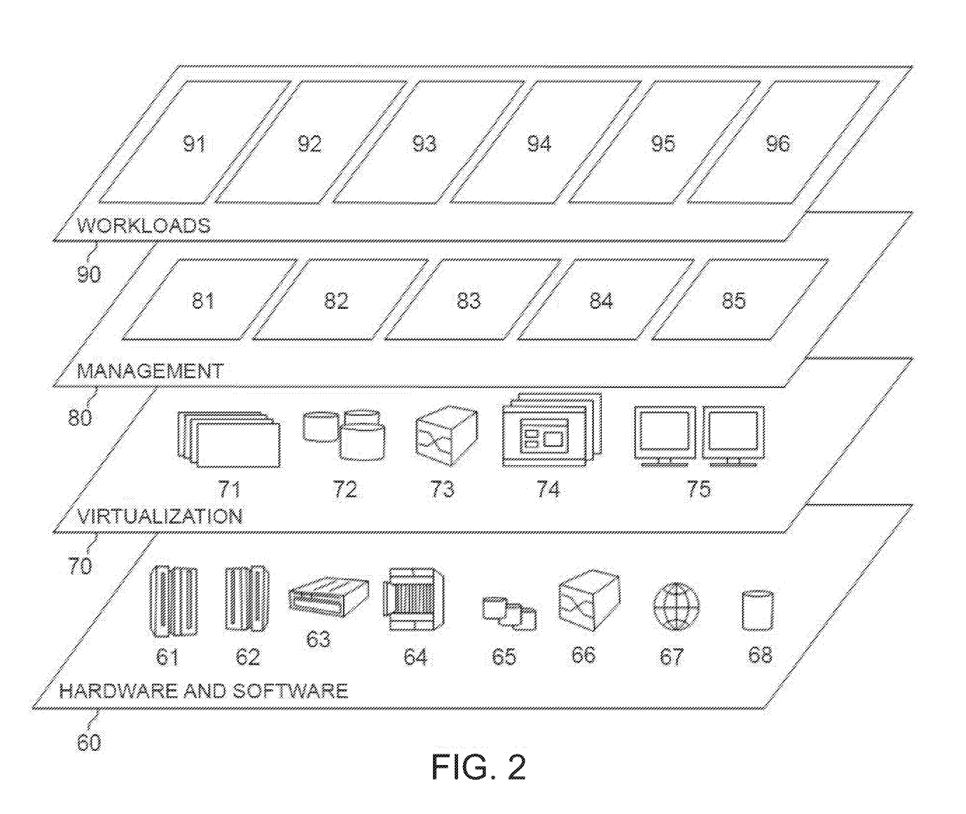

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing for automatically seeding ground truth files 96.

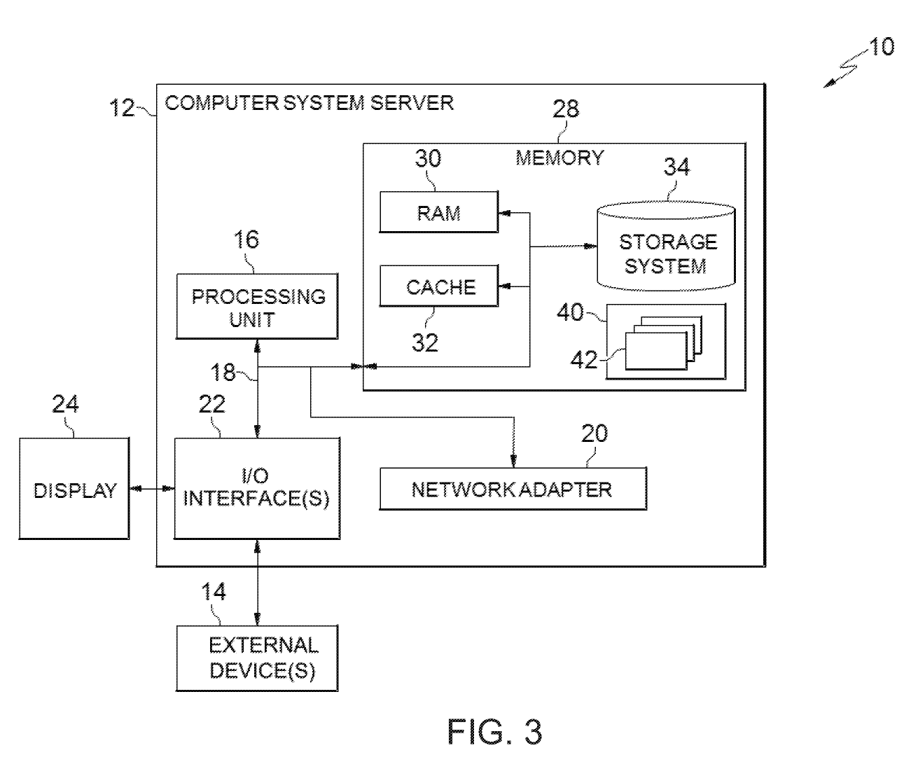

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

For cognitive search devices focused on searching databases for results from product or document universe, ground truth training data files are generated to include natural language expressions of a search query (question) that defines a set of search terms; a plurality of unique identification indicia (unique identifiers, Uniform Resource Locator (URL) addresses for web pages of content of the product or document, etc.) of different products or documents within the database universe that potentially satisfy the search query; and relevance scores that indicate how relevant each of the identified documents or products is to the natural language search term. The generated ground truth training data file is passed to a “create ranker” call or other process in order to generate and train result rankers.

Some training-data files are manually created and then pass to a “create ranker call” or other process that generates and trains a ranker. A create ranker application programming interface (API) generally expects (requires) a comma-separated-value (CSV) training-data file with feature vectors, wherein each feature vector represents a query-candidate answer pair and occupies a single row in the file. The first column of every row in such a file is the query ID used to group together all of the candidate-answer feature vectors associated with a single query, and the last column in the file is the ground-truth label (also called the relevance label), which indicates how relevant that candidate answer is to the query. The remaining columns are various features used to score the match between the query and the candidate answer . . . .

The following is an illustrative but not limiting or exhaustive ground truth file example:

Query, unique_idA_of_example_result, relevancy_rankingA_to_query, uniqueidB, relevancyB

“red dress shoes”,“PRODUCT˜12345”,5,“PRODUCT_6789”,1

“dog beds for elderly dogs”,“PRODUCT˜ABC”,5

In this example the item with the unique identifier “PRODUCT˜12345” has a high relevancy to a query similar to “red dress shoes” and should therefore be returned with that or a similar query. Alternatively, the item with the unique identifier “PRODUCT_6789” has a low relevancy and that product or similar products should not be returned by a query similar to “red dress shoes.”

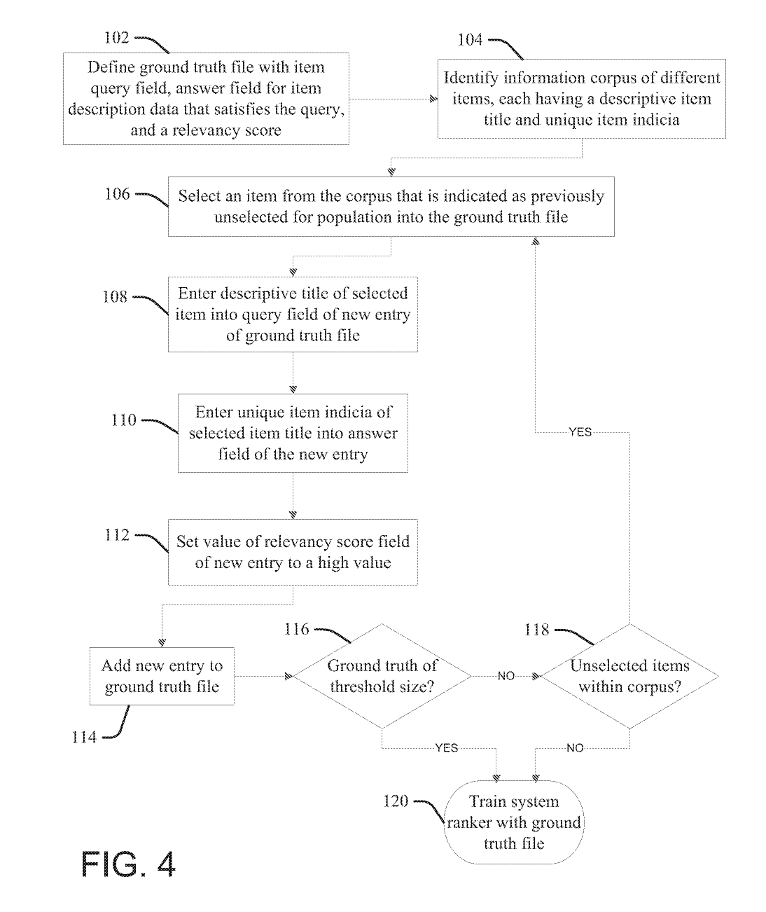

FIG. 4 illustrates a process or system according to the present invention that automatically seeds ground truth files for building cognitive search applications. At 102 a processor that is configured according to an aspect of the present invention (the “configured processor”) defines data fields for a ground truth file to comprise an item query field, an answer field for item description data that uniquely distinguishes an item that may satisfy the query from other items, and a relevancy score field for relevancy values that indicate the relevancy of the answer field data to the query field data. The configured processor may be implemented in accordance with the computer system server 10 of FIG. 3, including as the cloud node 10 of FIG. 1, as described respectively above.

At 104 the configured processor identifies a corpus of information (a catalog, database or other repository) that comprises a plurality of different items, wherein each item within the corpus has a descriptive item title (name or other descriptive identifier), and a unique item indicia associated with each titled item that distinguishes the item from other, similar items (for example, a unique product number, a web page Uniform Resource Locater (URL) address of a web page document item, a file name and a folder location for a file item stored on a storage device, etc.).

At 106 the configured processor selects an item from the item corpus that is indicated as previously unselected for population into the ground truth file defined at 102. For example, the configured processor reviews a flag field associated with the item to select only items wherein the value of the flag is not set to a “selected” value, and still other techniques will be apparent to one skilled in the art.

At 108 the configured processor enters the descriptive title of the selected item into the query field of a new entry of the defined ground truth file.

At 110 the configured processor enters the unique item indicia of the selected item title into the answer field of the new entry of the ground truth file.

At 112 the configured processor sets the value of the relevancy score field of the new entry of the ground truth file to a high, or highly relevant, value.

At 114 the configured processor adds (saves, etc.) the new entry to the ground truth file.

At 116 the configured processor determines whether the ground truth is large enough (for example, has a threshold size or number of query-answer-relevancy tuple entries) to train an automated search and retrieval ranker (a process configured by programming code to retrieve and rank item search results as a function of relevancy to a search query. The threshold values used to define an acceptably large-enough ground truth file may be set to any user-defined value.

If determined at 116 that the ground truth is not large enough, and at 118 that there are items within the corpus that have not yet been selected, the process or system iteratively returns to step 106 of the process to select another, as-of-yet unselected item, for population of another new entry for the ground truth file at steps 106-108-110-112-114.

Once determined at 116 that the ground truth meets the requisite threshold size, or at 118 that no more items remain unselected within the corpus, at 120 the configured processor trains the system ranker with the ground truth file, thereby assigning relevancy scores to the ground truth based on relationships between the descriptive titles and item indicia. More particularly, relevancy scores are assigned to items within the item database as a function of comparison of their descriptive title data to the query field descriptive title values of file entries of the ground truth file.

Aspects of the present invention are readily deployed with regard to catalog product search in retail domain, setting up a ground truth with only the product titles and product ID's, with all of them marked as highly relevant. This leverages an underlying attribute of product titles, wherein the text data used to define product titles is generally descriptive and highly relevant to the product described thereby (for example, a “front-loading clothes washer”, a “diesel-powered electric generator,” a “self-wringing mop,” etc.).

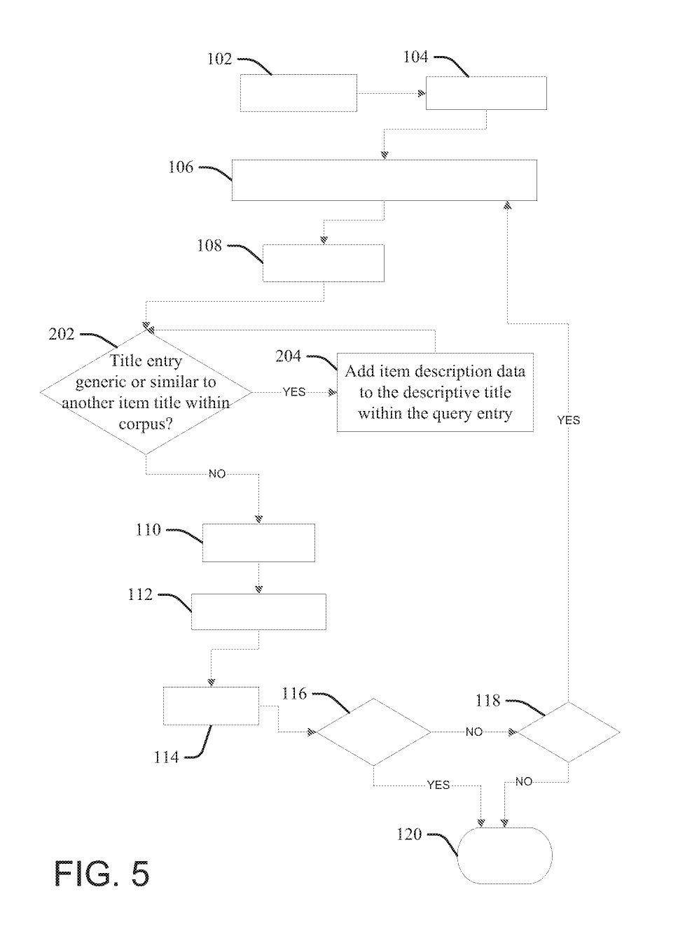

FIG. 5 illustrates an alternative embodiment of the present invention appropriate for catalogs wherein multiple items have similar or indistinguishable titles, or wherein the titles are generic or otherwise insufficiently descriptive (for example, a “washer”, a “clothes washer”, an “electric generator,” a “mop”, etc.). More particularly, additional processes or steps are incorporated into the elements of FIG. 4 as described above. Thus, in response to entry of the descriptive title of the selected item into the query field of the new entry of the defined ground truth file at 108, at 202 the configured processor determines whether said descriptive title entry is generic or similar to (thereby practically indistinguishable from) the title of another of the corpus items. For example, with respect to a corpus of home appliance products, the configured processor determines whether the title of “front-loading washer” entered at 108 is generic to multiple, different “front-loading washer” products within the corpus; or if specific to a subset of the products (for example, “Company X front-loading washer”), whether the distinguishing element of the subset (“Company X”) is nonetheless generic to other “front-loading washer” products of the same company found within the corpus.

If the descriptive title entry is determined to be generic at 202, at 204 the configured processor (iteratively) adds text content description information data associated with the item within the corpus data to the descriptive title data within the query field entry, comprising at least a portion of item attribute description data that is associated with the titled item, until the query entry is no longer determined to be generic to other item title data at 202. For example, where the title entry at 108 is “Company X front-loading washer,” the configured processor selects and adds additional text data to the entry field at 204. In one aspect, additional text is selected from an item description field, or key words selected therefrom that match a list of relevant key words or are otherwise determined to be relevant to the descriptive title (for example, one or more of product model number, type, color, size, capacity, type of energy used, efficiency rating, stackable attribute, front or top loading, steam cycle option, motor horse power, etc.) With regard to document items, the additional data may include document abstract text, publisher, copyright holder, distribution restrictions (“copyrights reserved,” or “public domain document”), file content description (“user manual”, “textbook selection”, etc.).

Adding the additional information may be incremental, adding a pre-defined number of words or different prioritized designated attribute items (incorporated options for a product, type of document, etc.) in each iteration of 204, until the query entry data is no longer generic to other item title data at 202, wherein the embodiment moves on to process or step 110 of FIG. 4 as described above.

It will also be appreciated that other embodiments of the process or system of FIG. 3 may add the additional narrative description text to the item title at step 108, within requiring the iterative determination processes 202 and 204.

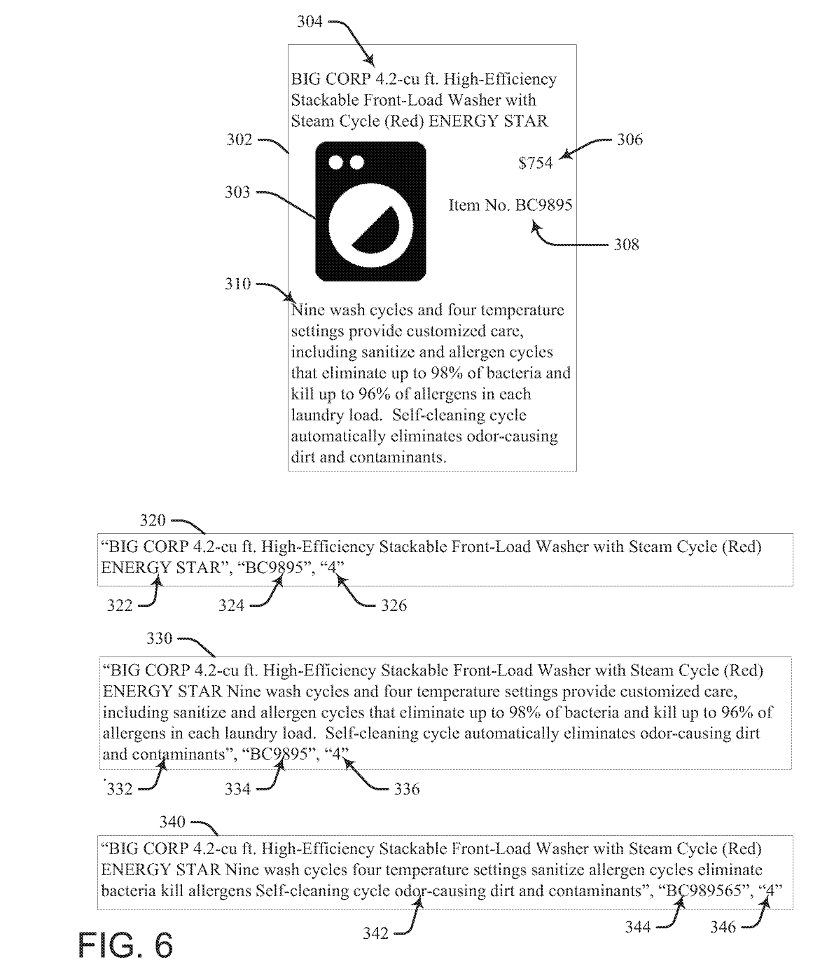

FIG. 6 illustrates exemplary ground truth file entries 320, 330 and 340 that are generated according to the present invention from a corpus catalog entry 302. The catalog entry 302 provides information for a clothes washer from a manufacturer, “BIG CORP.” The entry 302 includes an image 303 of the clothes washer and a descriptive item title field 304 that includes text data that is generic to other washers by the same manufacturer (“BIG CORP” and “Front-Load Washer”) as well as descriptive text data that may distinguish the item from other similar items by the same manufacturer (“4.2-cu ft., High-Efficiency, Stackable, with Steam Cycle, (Red), ENERGY STAR®). (ENERGY STAR is a trademark of the U.S. Environmental Protection Agency in the United States or other countries.)

The entry also includes the offering price 306 of the item (“$754”), unique item indicia 308 that distinguishes the item for all other items (a unique alphanumeric product identifier “Item No. BC9895”), and an item description field 310 that provides additional information about the item (“Nine wash cycles and . . . eliminates odor-causing dirt and contaminants.”).

Ground truth file entry 320 has a query of question field 322 that is demarcated by beginning and ending quotation marks and set off by a comma from a subsequent answer field 324 that has content also demarcated by quotation marks and which is set off by another comma from a relevancy field 326 that is has content also demarcated by beginning and ending quotation marks. The ground truth file entry 320 is generated according to the process or system of FIG. 4, wherein a processor configured according to the present invention (the “configured processor”) enters (at 108, FIG. 4) the text data of the descriptive title 304 into the query field 322 of the entry 320, said text data content demarcated by beginning and ending quotation marks (“BIG CORP 4.2-cu . . . ENERGY STAR”); enters (at 110, FIG. 4) a unique portion “BC9895” of the alphanumeric product identifier content 308 into the answer field 324; and sets (at 112, FIG. 4) the relevancy field 326 to a highly relevant value (“4”).

Ground truth file entry 330 has a query of question field 332 that is demarcated by beginning and ending quotation marks and set off by a comma from a subsequent answer field 334 that has content also demarcated by quotation marks and which is set off by another comma from a relevancy field 336 that is has content also demarcated by beginning and ending quotation marks. The ground truth file entry 330 is generated according to the process or system of FIG. 5, wherein a processor configured according to the present invention (the “configured processor”) enters (at 108, FIG. 5) the text data of the descriptive title 304 into the query field 332 of the entry 330, and also (at 204, FIG. 5) the text data of the item description field 310. The configured processor further enters (at 110, FIG. 5) a unique portion “BC9895” of the alphanumeric product identifier content 308 into the answer field 334; and sets (at 112, FIG. 5) the relevancy field 336 to a highly relevant value (“4”).

Ground truth file entry 340 has a query of question field 342 that is demarcated by beginning and ending quotation marks and set off by a comma from a subsequent answer field 344 that has content also demarcated by quotation marks and which is set off by another comma from a relevancy field 346 that is has content also demarcated by beginning and ending quotation marks. The ground truth file entry 340 is generated according to the process or system of FIG. 5, wherein a processor configured according to the present invention (the “configured processor”) enters (at 108, FIG. 5) an entirely of the text data of the descriptive title 304 into the query field 342 of the entry 330, and also (at 202-204, FIG. 5) iteratively adds keywords selected from the text data of the item description field 310 (“Nine wash cycles four temperature settings sanitize allergen cycles eliminate bacteria kill allergens Self-cleaning cycle odor-causing dirt and contaminants”). The configured processor further enters (at 110, FIG. 5) a unique portion “BC9895” of the alphanumeric product identifier content 308 into the answer field 344; and sets (at 112, FIG. 5) the relevancy field 346 to a highly relevant value (“4”).

In another example, first and second item products of a corpus catalog are both titled “garden hose,” wherein entry of either title alone as the query data field input at 108 of FIG. 5 would be found generic to the other at 202. However, the narrative description text provided for the first product within the catalog begins with “This kink free hose . . . ”; and the narrative description text provided for the second product within the catalog begins with “This watering hose features small holes to . . . ” Accordingly, adding these initial clause text items to the query field of a new seed question entry to the ground truth file will enable differentiation of the two products in training at 120.

Further, since the titles of the first and second “garden hose” products are an exact match, ground truth training may use the different, additional description data at 120 to differentiate their relative ground truth relevancy values. For example, the ground truth for the first product may be given a high relevancy score (for example, “3”), wherein the second product is listed as a related product relative to the first product (due to their generic product titles), but has a lower relevancy score (for example, “2”) for a user query, since the description data within its query field does not directly match the entry data for the first product.

In some embodiments, the item description data within the query fields is used to set respective item relevancies. In one example relevancy values for first and second items relative to each other are automatically set as function of comparing their respective query field description data, and thereby initialized or set to the lowest value (for example, “zero”) in response to determining little (de minimis) or no overlap of words or other discrete text terms of the item description text, beyond their generic title terms. Said relative relevancy values may also be increased in proportion to an amount of similarity or overlap of the respective, enhancing descriptive text.

Thus, aspects of the present invention create ground truth for a website catalog by scanning catalogs for relevant product titles, product identification indicia and product descriptions; seeding the ground truth with the relevant product titles, product identification indicia and product descriptions, and assigning relevancy scores to the ground truth, based on relationships between the product titles, product identification indicia and product descriptions.

Building a ground truth data training-data file under prior art processes and techniques is generally a manual and time consuming activity, especially when priming a system to be brought up when no search history has been previously saved. In contrast, aspects of the present invention easily and automatically create valid ground truths systemically, without requiring any manual inputs of relevancy designation values. Aspects enable machine learning processes and systems to be deployed relatively quickly for end users to use the system, and thereby generate more data for the system to be subsequently trained upon.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims, and as illustrated in the figures, may be distinguished, or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations, or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for automatically seeding ground truth files, comprising executing on a computer processor the steps of:
selecting an item from a corpus that comprises a plurality of different items, wherein each item within the corpus comprises a descriptive title and unique indicia;
entering the descriptive title of the selected item into a query field of a new entry for a ground truth file, wherein the ground truth file new entry comprises the query field, an answer field, and a relevancy score field;
entering the unique item indicia of the selected item title into the answer field of the new entry;
setting a value of the relevancy score field of the new entry to a high relevancy value; and
adding the new ground truth file entry to the ground truth file.

2. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the steps of selecting the item from the corpus, entering the descriptive title of the selected item into the query field of the new entry for the ground truth file, entering the unique item indicia of the selected item title into the answer field of the new entry, setting the value of the relevancy score field of the new entry to the high relevancy value, and adding the new ground truth file entry to the ground truth file.

3. The method of claim 2, wherein the computer-readable program code is provided as a service in a cloud environment.

4. The method of claim 1, further comprising:
training a ranker with the ground truth file.

5. The method of claim 4, further comprising, prior to the step of training the ranker:
iteratively repeating, until a total number of ground truth file entries of the ground truth file meets a threshold size, steps of:
selecting an additional item from the corpus;
entering the descriptive title of the selected additional item into a query field of a new entry for the selected additional item;
entering the unique item indicia of the selected additional item into an answer field of the new entry for the selected additional item;
setting a value of the relevancy score field of the new entry for the selected additional item to a high relevancy value; and
adding the new entry for the selected additional item to the ground truth file.

6. The method of claim 1, further comprising:
adding text content description information data associated with the selected item to the descriptive title data within the query field of the new entry.

7. The method of claim 6, further comprising:
adding the text content description information data associated with the selected item to the descriptive title data within the query field of the new entry in response to determining that the descriptive title of the selected item is generic to a descriptive title of another of the items within the corpus.

8. The method of claim 6, further comprising:
differentiating ground truth relevancy values of first and second ones of the corpus items with respect to a user query as a function of a difference in text content description information data added to their descriptive titles in their respective ground truth entry query fields.

9. The method of claim 8, further comprising:
setting a relevancy value of the first item relative to the second item to a value selected in proportion to an amount of overlap of discrete text terms of the text content description information data added to their descriptive titles in their respective ground truth entry query fields.

10. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
selects an item from a corpus that comprises a plurality of different items, wherein each item within the corpus comprises a descriptive title and unique indicia;
enters the descriptive title of the selected item into a query field of a new entry for a ground truth file, wherein the ground truth file new entry comprises the query field, an answer field, and a relevancy score field;
enters the unique item indicia of the selected item title into the answer field of the new entry;
sets a value of the relevancy score field of the new entry to a high relevancy value; and
adds the new ground truth file entry to the ground truth file.

11. The system of claim 10, wherein the processor executes the program instructions stored on the computer-readable storage medium via the computer readable memory and thereby uses the ground truth file to train a ranker.

12. The system of claim 11, wherein the processor executes the program instructions stored on the computer-readable storage medium via the computer readable memory and thereby, prior to using the ground truth file to train the ranker:
iteratively repeats, until a total number of ground truth file entries of the ground truth file meets a threshold size, steps of:
selecting an additional item from the corpus;
entering the descriptive title of the selected additional item into a query field of a new entry for the selected additional item;
entering the unique item indicia of the selected additional item into an answer field of the new entry for the selected additional item;
setting a value of the relevancy score field of the new entry for the selected additional item to a high relevancy value; and
adding the new entry for the selected additional item to the ground truth file.

13. The system of claim 10, wherein the processor executes the program instructions stored on the computer-readable storage medium via the computer readable memory and thereby:
adds text content description information data associated with the selected item to the descriptive title data within the query field of the new entry.

14. The system of claim 13, wherein the processor executes the program instructions stored on the computer-readable storage medium via the computer readable memory and thereby:
adds the text content description information data associated with the selected item to the descriptive title data within the query field of the new entry in response to determining that the descriptive title of the selected item is generic to a descriptive title of another of the items within the corpus.

15. The system of claim 13, wherein the processor executes the program instructions stored on the computer-readable storage medium via the computer readable memory and thereby:
differentiates ground truth relevancy values of first and second ones of the corpus items with respect to a user query as a function of a difference in text content description information data added to their descriptive titles in their respective ground truth entry query fields.

16. The system of claim 15, wherein the processor executes the program instructions stored on the computer-readable storage medium via the computer readable memory and thereby:
sets a relevancy value of the first item relative to the second item to a value selected in proportion to an amount of overlap of discrete text terms of the text content description information data added to their descriptive titles in their respective ground truth entry query fields.

17. A computer program product for automatically seeding ground truth files, the computer program product comprising:
a computer readable storage medium having computer readable program code embodied therewith, wherein the computer readable storage medium is not a transitory signal per se, the computer readable program code comprising instructions for execution by a processor that cause the processor to:
select an item from a corpus that comprises a plurality of different items, wherein each item within the corpus comprises a descriptive title and unique indicia;
enter the descriptive title of the selected item into a query field of a new entry for a ground truth file, wherein the ground truth file new entry comprises the query field, an answer field, and a relevancy score field;
enter the unique item indicia of the selected item title into the answer field of the new entry;
set a value of the relevancy score field of the new entry to a high relevancy value; and
add the new ground truth file entry to the ground truth file.

18. The computer program product of claim 17, wherein the computer readable program code instructions for execution by the processor further cause the processor to:
add text content description information data associated with the selected item to the descriptive title data within the query field of the new entry.

19. The computer program product of claim 18, wherein the computer readable program code instructions for execution by the processor further cause the processor to:
add the text content description information data associated with the selected item to the descriptive title data within the query field of the new entry in response to determining that the descriptive title of the selected item is generic to a descriptive title of another of the items within the corpus.

20. The computer program product of claim 18, wherein the computer readable program code instructions for execution by the processor further cause the processor to:
differentiate ground truth relevancy values of first and second ones of the corpus items with respect to a user query as a function of a difference in text content description information data added to their descriptive titles in their respective ground truth entry query fields.
